(19) United States
(12) Patent Application Publication
(10) Pub. No.: US 2025/0236041 A1
(43) Pub. Date: Jul. 24, 2025

(54) ELECTRIC POWER TOOL

(71) Applicant: HUSQVARNA AB, Huskvarna (SE)

(72) Inventors: Martin Larsen, Jonkoping (SE); Jens Elmwall, Motala (SE); Johan Landen, Jonkoping (SE); Rebecca Jonasson, Jonkoping (SE)

(21) Appl. No.: 18/697,848

(22) PCT Filed: Sep. 5, 2022
(86) PCT No.: PCT/SE2022/050787

§ 371 Date: Apr. 2, 2024

(30) Foreign Application Priority Data
Oct. 8, 2021 (SE) 2151240-5

(51) Int. Cl. B27B 17/00; B23D 59/00; G08B 21/18

(52) U.S. Cl. CPC B27B 17/00; B23D 59/001; G08B 21/182

(57) ABSTRACT

The present disclosure relates to an electric power tool (1) comprising at least one handle (31, 33) and an active tool part (2, 4) powered by and electric motor (5), wherein the electric motor is powered by a supply unit (13, 23) controlling the electric motor torque. A control unit (41) detects a condition to be communicated to a user of the power tool, and to vary, for instance using field-oriented control, FOC, the motor torque according to a predetermined pattern as a notification in response to the condition, such that a motion of the tool (1) is produced or a characteristic sound pattern. Such a notification can be relatively easily noticed by a user under working conditions.

### TECHNICAL FIELD

The present disclosure relates to an electric power tool such as an electric chain saw comprising at least one handle and an active tool part powered by and electric motor, wherein the electric motor is powered by a supply unit controlling the electric motor torque.

### BACKGROUND

Such power tools have found a widespread use and, in many cases, can even replace internal combustion engine tools even if being battery-operated. Using such a tool often means making a lot of noise and always requires the user's attention to operate in a safe and efficient manner. Making the user aware of certain conditions can therefore be challenging.

### SUMMARY

One object of the present disclosure is therefore to provide a power tool that can notify the user about certain conditions in an efficient and safe manner.

This object is achieved by means of a power tool as defined in claim 1. More particularly, in a power tool of the initially mentioned type, there is provided a control unit configured to detect a condition to be communicated to a user of the power tool, and to vary, for instance using field-oriented control, FOC, the motor torque according to a predetermined pattern as a notification in response to the condition, such that a motion of the tool and/or a characteristic sound pattern is produced. This, in many cases, makes it possible for the user to feel, in the tool handles, a communicated notification, in the case of a chainsaw for instance a notification about a low chain saw level. This can be done without producing a loud sound using separate means such as a piezo-electric buzzer and without the user deflecting his attention from the work process e.g. to look at an indicator lamp. Even if the rotor is light compared to the remainder of the tool, the torque variation may at least produce a characteristic variation in the sound pattern of the tool itself that the user may hear despite wearing ear protection. Therefore, the detected condition is communicated in a safe and reliable manner.

The torque may be varied with pulsations superimposed on a base torque, each pulsation including a positive phase exceeding a base torque and a negative phase being lower than the base torque. These pulsations are superimposed on a base torque, e.g. controlled by a user. For a consecutive set of one positive phase and one negative phase, an added torque of the positive phase times the positive phase length during the positive phase is equal to the subtracted torque times the negative phase length during the negative phase. This means that the pulsation as a whole does not change the rotational speed of the motor, such that the speed remains the one set by the user when the pulsation has been concluded.

The order of the positive and negative phases may be changed to communicate different notifications.

The predetermined pattern may comprise a plurality of predetermined subpatterns, and the interval between subsequent subpatterns may be changed to communicate different notifications.

The predetermined pattern may include different subpatterns with grouped pulsations.

The tool is configured to forward notifications when a clutch is disengaged such that the motor is freewheeling. This makes it easier to detect a notification as it is produced at a time when the tool is not engaged, and fewer other sounds/movements are produced.

The control unit may thus be configured to cache an event for later communication to the user and, in response to the clutch being disengaged or being presumed to be disengaged, generating a corresponding predetermined torque pattern. The user then receives the notification when less attention to the active part, such as a saw sword, is needed.

The power tool is an electric chain saw. Then, one typical notification is related to low chain oil level.

One typical notification is, in a battery-operated system, caused by a low battery level.

Other notifications may be caused by an inability of the motor to reach above a predetermined rotational speed, or by a prolonged overload condition, for instance. It is also possible to provide the power tool with a wireless interface. This makes it possible to communicate with other devices nearby, such as mobile phones, etc. A notification, indicating for instance reception of an e-mail or text message, may then be received via the interface, and forwarded to the user by varying the torque as discussed above.

The present disclosure also considers a method for providing a notification to the user of an electric power tool, the method comprising detecting a condition to be communicated to the user of the power tool and varying the motor torque according to a predetermined pattern in response to the condition, such that a motion of the tool and/or a characteristic sound pattern is produced.

This method provides advantages corresponding to the discussion above and can be varied and altered in the same way.

### BRIEF DESCRIPTION OF THE DRAWINGS

FIG. 1 shows an electric chainsaw.

FIG. 2 illustrates schematically a motor power supply and control system.

FIGS. 3A and 3B illustrate very schematically a model of the chain saw in FIG. 1 when providing haptic feedback so a user.

FIGS. 4A to 4D illustrate different communication modes.

FIG. 5 illustrates units of a system providing notifications.

### DETAILED DESCRIPTION

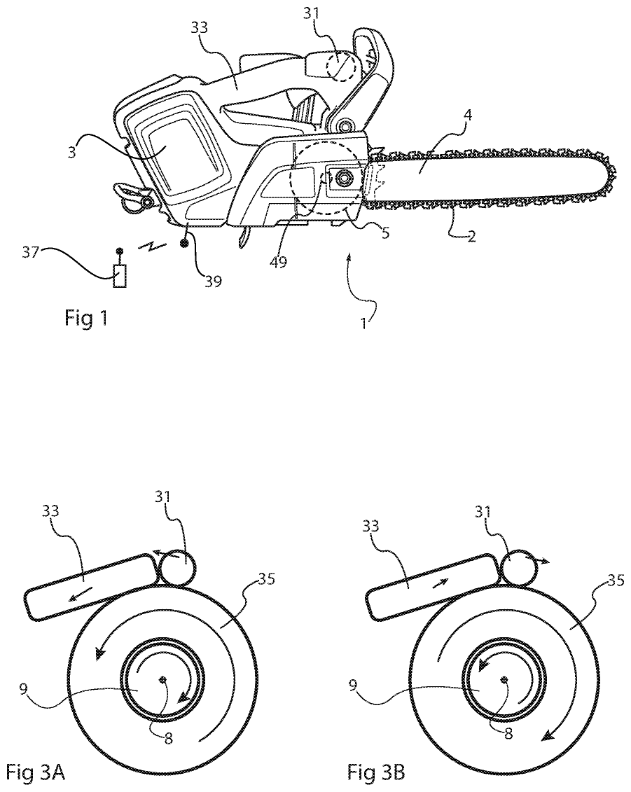

The present disclosure relates to an electric power tool such as an electric chainsaw 1 as illustrated in FIG. 1. It should be noted, however, that the present disclosure is applicable to any handheld power tool comprising a motor, the torque of which is controllable.

This chainsaw 1 is powered by a battery 3 although the present disclosure would also be applicable to power tools powered from and electric power outlet by means of a power cable. The chainsaw comprises a saw chain 2 supported by a guide bar 4 and driven by an electric motor 5, the location of which is indicated in FIG. 1. Even if it would be possible to orient the axis of the electric motor 5 in different ways, for instance using a worm gear, it is preferred to align the motor axis with the normal of the guide bar 4 plane such that the motor 5 may drive a driving chain sprocket (not shown) more or less directly. However, as will be discussed, it may be advantageous in the context of this disclosure to provide a clutch 49 between the electric motor 5 and the driving sprocket.

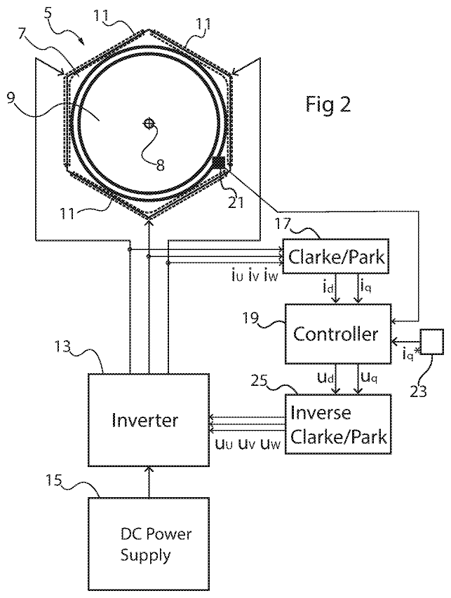

An electric motor 5 power supply and control system is schematically illustrated in FIG. 2. The electric motor 5 comprises a stator 7 and a rotor 9, concentric with the stator. In the illustrated example, the electric motor is a brushless DC, BLDC, motor or permanent magnet synchronous motor, PMSM, having a permanent-magnet rotor. The stator may typically be a multi-phase stator, usually with three-phase windings, U/V/W, 11. However, it would be possible in the context of the present disclosure to instead use an asynchronous- or reluctance type motor.

The windings 11 are controlled by an inverter 13 using a field-oriented control, FOC, scheme. The inverter 13 receives power from a DC power supply 15, such as a chargeable battery, and feeds power to the motor windings 11 according to a pulsewidth modulation scheme. A step-up converter may be included in the power supply 15 or the inverter 13 to increase the voltage applied to the windings 11.

To employ FOC, the currents iᵤ, iᵥ i_{w} applied to each winding 11 may be measured and a converter may convert those currents by means of a Clarke/Park conversion unit 17 into direct and quadrature currents, relating to the currents parallel (direct) i_{d} and perpendicular (quadrature) i_{q}, respectively, to the instantaneous magnetic field of the rotor 9, in the latter's coordinate system, as is well known per se. Those converted currents are fed to a controller 19, and a sensor output from an optional angular position sensor 21 estimating the orientation of the rotor 9 may be fed to the controller 19 as well. The controller 19 generally performs a control operation, such as based on a PI-control scheme, in order to minimize the parallel current component, which does not contribute to rotor torque, and to obtain a desired perpendicular component, that does generate torque, based on an input desired torque value i_{q}* from an input unit 23. The controller in this way produces direct and quadrature u_{d}, u_{q} voltages that are converted, using an inverse Clarke and space vector modulation, SVM, modulation unit 25, into desired inverter duty cycle values dᵤ, dᵥ, d_{w} for control of the inverter to create corresponding winding voltages uᵤ, uᵥ u_{w}. This technique is well known per se.

The conversion units 17, 25 may typically be integrated with the controller 19 which may be software-implemented.

The present disclosure uses this control arrangement to communicate with the user of the power tool. In some environments, certainly including using chainsaws, providing indications to a user is difficult. When sawing a log or felling a tree, for instance, the user is unlikely to become aware of an indicator lamp flashing, and indeed it would be questionable to distract the user in such a way that visual attention is diverted from a difficult task. Using a beeping sound by a buzzer or the like is even more difficult as the user should wear ear protection and a chain saw in use can produce sound pressure levels exceeding 100 dB. Typical vibration notification devices such as piezo-electric elements are equally unfeasible as a chain saw in use often vibrates a lot, and the user should wear protective gloves.

In the present disclosure, there is instead provided haptic feedback or notifications to the user using the motor control system, or characteristic sound patterns using the motor itself.

Returning to FIG. 1, the illustrated chain saw 1 has two handles, a front handle 31, which is hidden in the view of FIG. 1, and a rear handle 33. The illustrated chainsaw is a compact saw where the handles 31, 33 are located close to each other, but the present disclosure is equally applicable to handle configurations where the rear handle is located close to the rear end of the chain saw. Also, power tools with only one handle can employ the teaching of the present disclosure.

FIGS. 3A and 3B illustrate very schematically a model of the chain saw in FIG. 1 when providing haptic feedback to a user. Generally, the system comprises an inner part, that is the rotor 9, and an outer part 35, comprising the stator 7 and the remainder of the tool as a whole. The rotor 9 is substantially centered around the rotor axis 8 around which it rotates. The remainder 31, 33, 35 of the tool of course has a more uneven mass distribution, but at least encloses the rotor axis 8. The torque applied in the air gap between the rotor 9 and the stator 7 of course acts on the rotor, typically accelerating the same. However, an equal opposing torque of course influences the stator 7 and the remainder of the tool.

The rotor has a rotational inertia (or moment of inertia) J_{R}, which its defined by its mass and that mass' distribution in relation to the rotor axis 8. The remainder of the tool 31, 33, 35 can also be said to have a rotational inertia J_{S} in relation to the rotor axis 8. This is an approximation as the mass of the remainder of the tool is likely not centered at the rotor axis 8, the stator 7 being an exception. However, for the purpose of this disclosure this approximation is acceptable. In most tools the rotor will have a significantly lower rotational inertia than the remainder of the tool due to the rotor's lower mass and that mass' closer proximity to the rotor axis 8. This is for sure the case in an electric chain saw.

Applying a torque τ to the rotor (which is here considered to rotate freely not applying any load to the tool part) makes it accelerate (or decelerate) with a rotor angular acceleration according to the formula

$${α}_{R} = \frac{τ}{{J}_{R}}$$

The same torque is applied to the remainder of the tool on the other side of the air gap resulting in an angular acceleration

$${α}_{S} = \frac{τ}{{J}_{S}}$$

but as the ratio J_{R}/J_{S} for almost any tool, and certainly a chainsaw, will be far below 1, the angular acceleration of the tool as a whole is easily countered by the person holding the tool in the handles 31, 33. Nevertheless, application of a torque to the rotor 9 and a resulting opposing torque to the remainder 31, 33, 35 of the tool may be felt by the user. The present disclosure uses this feature to communicate notifications to the user. It has been understood that such notifications are much more easily recognized during use of the tool than for instance a blinking indicator lamp or similar. In cases where the rotor 9 has a much lower rotational inertia than the remainder of the tool 31, 33, 35, it may not be possible to feel the handles' 31, 33 movements resulting from the torque changes, but the variation still may produce a distinct sound pattern variation from the varying speed in the operation of the tool itself which may be clearly detectable despite wearing ear protection.

In FIGS. 3A and 3B, the arrows indicate angular acceleration provided by applying torque in different directions to the rotor 9. It should be noted that the rotor 9 may maintain rotation in one direction while accelerating and decelerating, there is thus no need to reverse the direction of rotation.

It is thus possible to notify the user about certain conditions concerning the use of the tool, but also other information. The types of notifications may vary depending on the type of tool. For an electric chainsaw it may typically be useful to notify the user when the level of chain oil is running low, so that the user remembers to fill the chain oil container regularly. An early warning of low battery may also be produced. Additionally, it may in some cases be provide feedback regarding the use of the tool, for instance informing the user that the tool is being overloaded in such a way that it may run hot. As a part of such a scheme it is possible to more or less continuously provide a user with feedback regarding the use of the tool to assist the user in improving his skills.

As indicated in FIG. 1, the disclosed arrangement may also be used to forward notifications from secondary devices 37 paired with the chain saw or another power tool. Illustrated there is a cell phone 37 that communicates with a radio interface 39 in the tool, typically a short-range interface such as BLUETOOTH. It is thereby made possible for instance to notify the user of a chainsaw that his cell phone has received a text message or e-mail, just as one example.

It may therefore be possible to provide several different notifications and in such a way that it allows the user to distinguish between them.

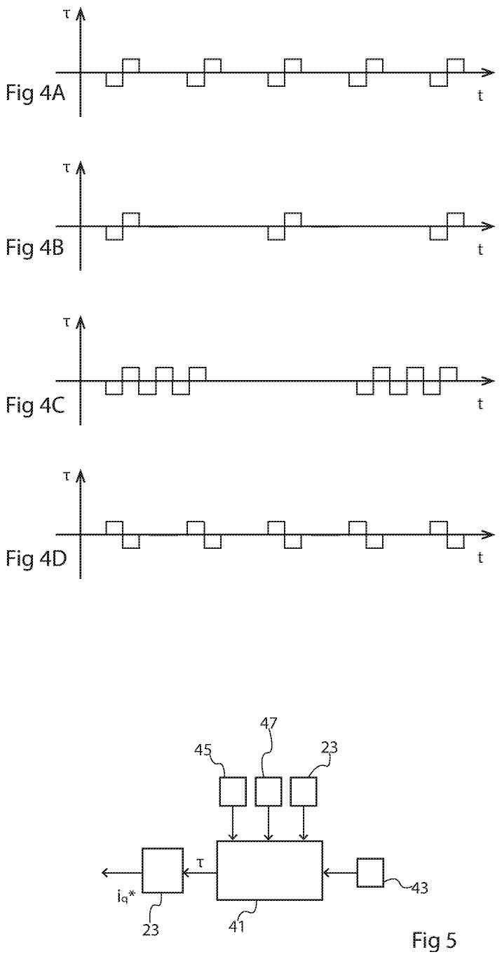

FIGS. 4A-4D illustrate different ways for obtaining this. Usually, for example in a chainsaw, the user controls the speed of the motor with a throttle button or the like, and this as well is done by changing the torque applied to the rotor. This is usually done with a continuously variable resistor connected to the button or the like. To distinguish itself from a user-induced change of the torque a notification may typically be carried out by changing the torque substantially stepwise manner, e.g. approximately a square wave. The torque functions illustrated in FIGS. 4A-D may thus be superimposed to a torque function provided by the user.

In FIG. 4A, the torque is varied by first abruptly reducing the torque compared to the base value, then similarly abruptly increasing it above the initial base value. A torque pulse may thus have a positive and a negative phase, where the duration of both phases times its respective deviation from the base value is the same. This means that the pulse does not result in a lasting change in rotor speed, nevertheless the pulse can be felt by the user as a quick pull-push movement in the tool handles 31, 33 as indicated in FIGS. 3A and 3B. There may however exist situations where also a remaining change in speed is desired.

The torque variation needed to ensure that a normal user senses the notification depends on how the tool is used and the rotational inertias involved and can be determined through experimentation.

In the example in FIG. 4A, a single torque pulsation is repeated relatively frequently, e.g. once per second. This may be used for instance to warn about a low chain oil level. If it is desired to provide another, distinguishable notification, for instance battery-low, this may be done by providing considerably less frequent pulsations, e.g. every tenth second as illustrated in FIG. 4B (not in scale).

Another option is shown in FIG. 4C where multiple pulsations are provided in groups, which may also provide a notification which can be distinguished from the others. A fourth option is illustrated in FIG. 4D where the order of torque increase and torque decrease is reversed which as well may be distinguished from the notification of FIG. 4A.

FIG. 5 illustrates units of a system providing the notifications. A control unit 41 provides a control signal to the input unit 23, cf. FIG. 2. Under circumstances where no notification is to be sent, this unit simply forwards a signal corresponding to a signal from a user input 43, such as a throttle button or the like, based on which a desired current i_{q}* resulting in a torque is determined by the input unit 23. The control unit 41 also receives information from one or more sensors 45, such as a chain oil level sensor or battery level sensor. Based on input from such sensors a torque pulsation may be superimposed on the desired torque signal. As mentioned, it is also possible to receive notifications from external devices via a communications interface 47.

If the power tool is provided with a clutch 49 as indicated in FIG. 1, it may be preferable to transmit notification as the clutch is active, i.e. when the motor is freewheeling rather than being connected to the chain sprocket or other implement driving device. Freewheeling in this case means that the motor is running but is not connected to the active tool part such as a saw chain, this may be useful to maintain an intermittent speed making the rotor attain a driving speed more quickly and to keep for instance a cooling fan running.

Providing a notification while freewheeling makes it easier to notice the notification, as for instance sawing a log causes disturbances that can make the haptic or acoustic sensing of the notification more difficult. This also improves safety as the user is likely not disturbed when carrying out a difficult task. Therefore, returning to FIG. 5, the control unit may also comprise an input from the clutch 49, thereby being able to queue any notifications until the clutch is released and the motor is freewheeling, such that the notifications can be more easily detected. It is in many cases also possible for the control unit 41 to deduct a free-wheeling condition, e.g. based on the rotational speed if a centrifugal clutch is used.

The invention is not restricted to the described embodiments and may be varied and altered in different ways within the scope of the appended claims.

1. An electric power tool, wherein the power tool is an electric chain saw, the power tool comprising at least one handle, an active tool part powered by an electric motor and a control unit, wherein the electric motor is powered by a supply unit controlling electric motor torque, wherein the control unit is configured to detect a condition to be communicated to a user of the power tool, and to vary, using field oriented control, FOC, the motor torque according to a predetermined pattern as a notification in response to the condition, such that a motion of the power tool and/or a characteristic sound pattern is produced, the power tool being configured to forward notifications when a clutch is disengaged such that the motor is freewheeling.

2. The electric power tool according to claim 1, wherein the electric motor torque is varied with pulsations superimposed on a base torque, each pulsation including a positive phase exceeding the base torque and a negative phase being lower than the base torque.

3. The electric power tool according to claim 2, wherein the pulsations are superimposed on the base torque controlled by the user.

4. The electric power tool according to claim 2, wherein, for a consecutive set of one positive phase and one negative phase, an added torque of the positive phase times a positive phase length during the positive phase is equal to a subtracted torque times a negative phase length during the negative phase.

5. The electric power tool according to claim 2, wherein an order of the positive and negative phases is changed to communicate different notifications.

6. The electric power tool according to claim 1, wherein said predetermined pattern comprises a plurality of predetermined subpatterns, wherein intervals between subsequent subpatterns are changed to communicate different notifications.

7. The electric power tool according to claim 1, wherein said predetermined pattern includes subpatterns with grouped pulsations.

8. The electric power tool according to claim 1, wherein the control unit is configured to cache an event for later communication to the user and, in response to the clutch being disengaged, generating a corresponding predetermined torque pattern.

9. The electric power tool according to claim 1, wherein the notification is caused by a low chain oil level.

10. The electric power tool according to claim 1, wherein the notification is caused by a low battery level.

11. The electric power tool according to claim 1, wherein the notification is caused by an inability of the motor to reach above a predetermined rotational speed, or by a prolonged overload condition.

12. The electric power tool according to claim 1, comprising a wireless interface and wherein the notification is received via the interface and forwarded to the user by varying the electric motor torque.

13. A method for providing a notification to the user of an electric power tool, wherein the power tool is an electric chain saw, the method comprising detecting a condition to be communicated to the user of the power tool and, when a clutch is disengaged such that the motor is freewheeling, varying the motor torque according to a predetermined pattern in response to the condition, such that a motion of the tool and/or a characteristic sound pattern is produced.
